(19) United States
(12) Patent Application Publication
(10) Pub. No.: US 2006/0104565 A1
(43) Pub. Date: May 18, 2006

(54) Optical semiconductor module

(75) Inventors: Naoyuki Shimada, Tokyo (JP); Tetsuya Yagi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/073,569

(22) Filed: Mar. 8, 2005

(30) Foreign Application Priority Data
Oct. 27, 2004 (JP) 2004-311798

(51) Int. Cl. G02B 6/12

(52) U.S. Cl. 385/14

(57) ABSTRACT

An optical semiconductor module includes at least one semiconductor chip including at least one laser diode, a sub-mount or a heat sink, on which the at least one semiconductor chip is mounted, and a bonding wire supplying an operating current to the semiconductor chip. The material, diameter, and shape of the bonding wire are selected so that the bonding wire fuses itself when an overcurrent exceeding the operating current of the laser diode is applied.

### BACKGROUND OF THE INVENTION

1. Field of the Invention

The present invention relates to an optical semiconductor module.

2. Background Art

Conventionally, as a method to obtain a large optical power by an optical semiconductor module, a plurality of laser diodes (hereinafter referred to as LD) has been aligned on a sub-mount, a plurality of single LDs has been included in one semiconductor chip, or a known LD bar has been constructed from a plurality of LDs (for example, refer to paragraph 0030 and FIG. 1 of Japanese Unexamined Patent Application Publication No. 2002-232061).

A conventional high power LD array is generally constructed in a state that respective single LDs are connected in parallel electrically. In the case of the LD bar, which is particularly often used, since it is inevitable that a substrate should be a terminal common to the respective LDs, all LDs are connected in parallel. Therefore, when one single LD causes a short circuit trouble, a current supplied to the whole array concentrates on the LD in trouble, and no current is supplied to the other LDs. In result, it leads to a problem that despite that the other LDs have capability to operate well, oscillation of the whole array is stopped.

### SUMMARY OF THE INVENTION

The present invention has been made to solve the above problems. It is an object of the present invention to provide an LD array, wherein, even when one single LD causes a short circuit trouble, a function to be able to continue oscillation of the other LDs in the same array can be obtained without specially using a fuse outside the LDs, and wherein in the case of constant current driving, a loss of an optical power from the LD in the short circuit trouble can be compensated by automatically applying a current which has flowed in the LD in trouble until the short circuit is caused to the other LDs in parts and increasing currents to flow in the other LDs.

The above object is achieved by an optical semiconductor module comprising one or a plurality of semiconductor chips respectively including one or a plurality of laser diodes, a sub-mount or a heat sink, which mounts the one or the plurality of semiconductor chips, and a bonding wire supplying an operating current to the semiconductor chip, wherein a material, a diameter, and a shape of the bonding wire are selected so that the bonding wire fuses itself when a given overcurrent over the operating current of the laser diode is applied.

Other objects and further features of the present invention will be apparent from the following detailed description when read in conjunction with the accompanying drawings.

### BRIEF DESCRIPTION OF DRAWINGS

FIG. 1 is a perspective view showing an outline construction of the first embodiment;

FIG. 2 is a circuit diagram of the LD array of the first embodiment;

FIG. 3 is a perspective view showing an outline construction of the second embodiment;

FIG. 4 is a circuit diagram of the LD array of the second embodiment;

FIG. 5 is a perspective view showing an outline construction of the third embodiment;

FIG. 6 is a circuit diagram of the LD array of the third embodiment;

FIG. 7 is a perspective view showing an outline construction of the fourth embodiment; and

FIG. 8 is a circuit diagram of the LD array of the fourth embodiment.

### BEST MODE FOR CARRYING OUT THE INVENTION

Now, embodiments of the present invention will be described with reference to the drawings. Like reference numerals denote like components throughout the drawings, and redundant descriptions will be omitted.

### FIRST EMBODIMENT

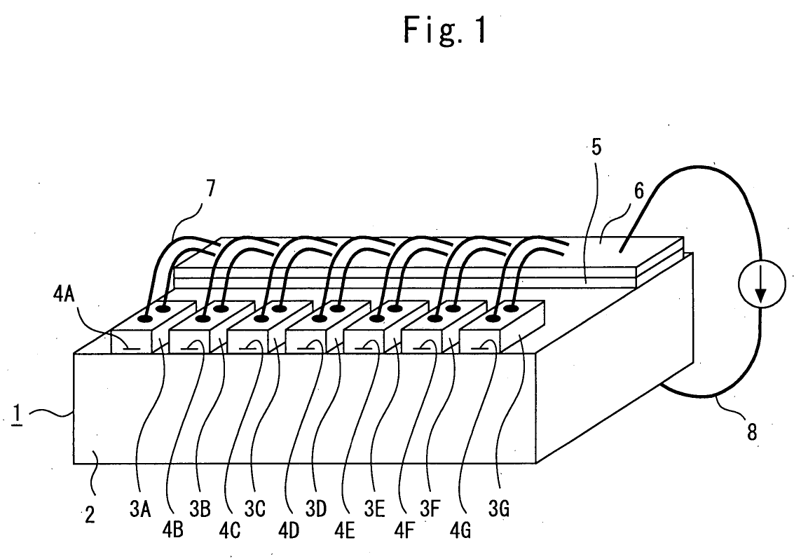

Descriptions will be hereinafter given of a first embodiment of the invention with reference to the drawings. FIG. 1 is a perspective view showing an outline construction of the first embodiment.

As shown in this figure, an LD array 1 of the first embodiment is constructed so that a plurality of single LDs 3A to 3G is mounted on a sub-mount 2 made of conductive CuW, a metal plate 6 becoming a conductive part through an insulating plate 5 is mounted in a position estranged from the respective single LDs, and the respective LDs 3A to 3G and the metal plate 6 are connected through a bonding wire 7. A drive circuit 8 of the LD array 1 is connected between the metal plate 6 and the sub-mount 2.

The respective LDs 3A to 3G are mounted so that respective pn junction sides (not shown) are located on the sub-mount 2 side.

The bonding wire 7 is constructed by bundling, for example, seven wires being 25 μm in diameter made of a gold material (Au). A material, a diameter, and the number of wires of the bonding wire 7 are selected so that the bonding wire 7 fuses itself and releases the LD electrically, when overcurrent of 5 A to 6 A in relation to normal operating current of 1 A (500% to 600% in relation to the operating current), which is supplied to the respective LDs from the drive circuit 8 through the metal plate 6 is applied. That is, when the bonding wire made of Au is used, the diameter and the number of wires can be selected so that a current density in the wire becomes 1.46×10⁵ A/cm² to 1.75×10⁵ A/cm² when the overcurrent of 5 A to 6 A is applied to the LD. For example, when the diameter of the wire is 20 μm, the bonding wire can be constructed by bundling 11 wires. When the diameter of the wire is 30 μm, the bonding wire can be constructed by bundling five wires. Further, the descriptions have been given of the LD whose normal operating current is 1 A. Meanwhile, in the case of an LD whose normal operating current is 0.8 A, the material, the diameter, and the number of wires of the bonding wire can be selected so that the bonding wire 7 fuses itself and releases the LD electrically, when overcurrent of 4 A to 4.8 A (500% to 600% in relation to the operating current) is applied. Here, the descriptions have been given of the preferred embodiment. However, the lower limit of the diameter of the wire and the number of wires of the bonding wire can be a value obtained by multiplying a value at which the bonding wire does not fuse itself at the normal operating current of the LD by a safety coefficient. The upper limit of the diameter of the wire and the number of wires of the bonding wire can be a value at which the bonding wire fuses itself at either smaller value of a current value at which the LD is completely damaged (10 A in this embodiment) and a value, “the number of LDs mounted on the LD array 1 “×” the normal operating current value of LD.” Further, 4A to 4G represent light emitting regions of the respective LDs.

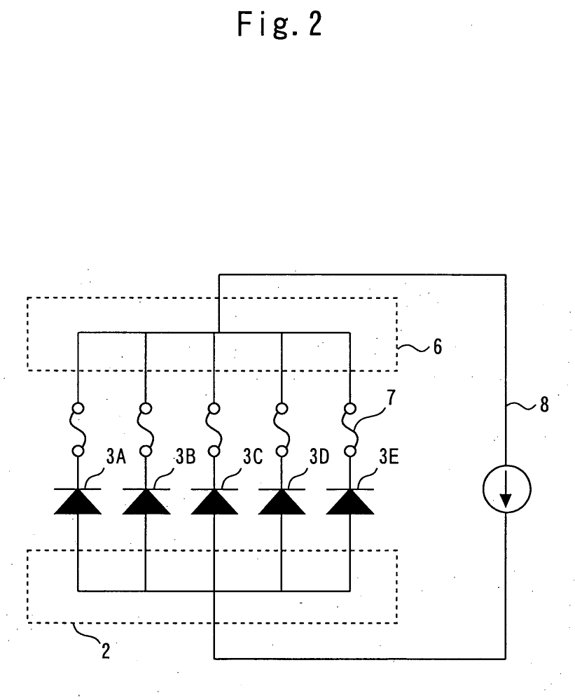

FIG. 2 shows a circuit diagram of the LD array 1. However, regarding the LD, only 3A to 3E are shown. When one single LD, for example, 3A causes a short circuit trouble while the LD array 1 is driven, an electric potential difference between both ends of the LD 3A becomes significantly small. In result, a larger current, for example, overcurrent of 5 [A] to 6 [A] in relation to operating current of 1 [A] is applied to the LD 3A. Due to this overcurrent, the bonding wire 7 fuses itself. Therefore, the LD 3A which has caused the short circuit trouble is automatically separated from the circuit.

When the LD array 1 has been driven at a constant current, the current, which has flowed in the LD 3A in trouble is applied to the other LDs 3B to 3E in parts. Therefore, oscillation as a whole array can be continued. Further, oscillation of the LD 3A in trouble is stopped and an optical power from the LD 3A becomes 0. However, optical powers of the other LDs 3B to 3E are increased little by little by the current applied to the other LDs 3B to 3E in parts, which compensates the loss of optical power by oscillation stop of the LD 3A in trouble. This function that the optical power is automatically compensated during constant current driving is similar in other embodiments described later.

### SECOND EMBODIMENT

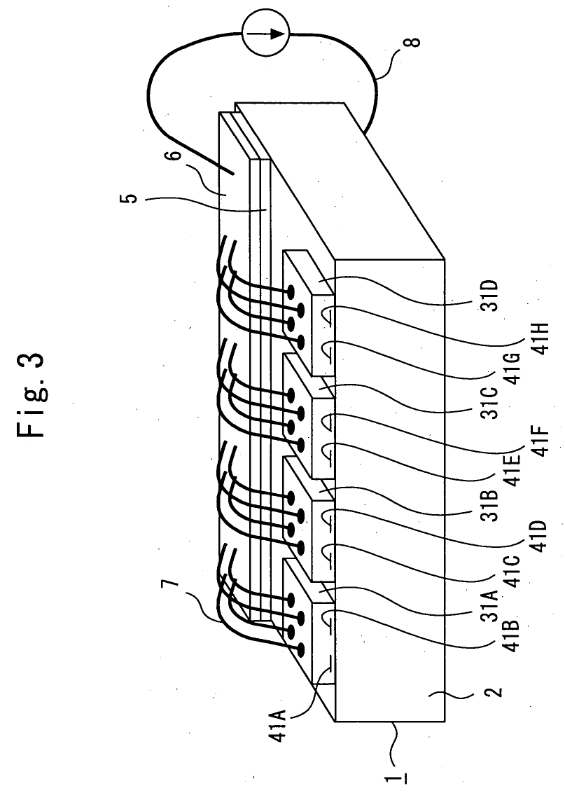

Next, a second embodiment of the invention will be described with reference to the figures. FIG. 3 is a perspective view showing an outline construction of the second embodiment. In this figure, the same symbols as in FIG. 1 are applied to components identical with or corresponding to in FIG. 1, and descriptions thereof are omitted.

In FIG. 3, 31A to 31D are semiconductor chips including a plurality of single LDs. The respective semiconductor chips 31A to 31D are mounted so that respective pn junction sides (not shown) of the respective LDs are located on the conductive sub-mount 2 side. 41A to 41H represent light emitting regions of the plurality of LDs included in the respective semiconductor chips.

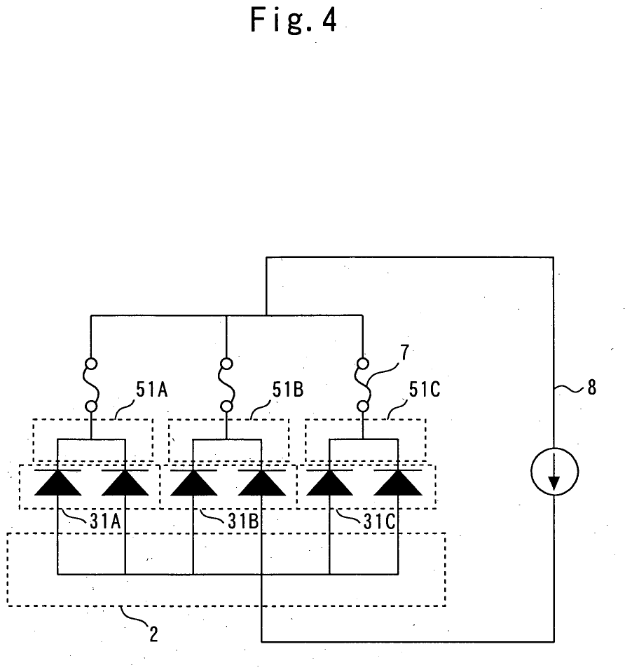

FIG. 4 shows a circuit diagram of the LD array 1 of FIG. 3. However, regarding the semiconductor chip, only 31A to 31C are shown. Further, 51A to 51C represent substrate parts of the respective semiconductor chips 31A to 31C. Since the plurality of single LDs included in the same semiconductor chip has a common substrate, the circuit diagram is shown as FIG. 4.

When one LD of the plurality of LDs included in one semiconductor chip, for example, 31A causes a short circuit trouble, the bonding wire 7 connected to the semiconductor chip 31A fuses itself. Therefore, the semiconductor chip 31A is separated from the circuit, and current supply to the semiconductor chip 31A is automatically stopped. However, other semiconductor chips 31B and 31C can continue oscillation.

Compared to in the first embodiment, the number of LDs separated from the circuit along with the semiconductor chip thereof is larger when the short circuit trouble is caused in one semiconductor chip. However, this embodiment has the effect that the number of the semiconductor chips to be mounted in manufacturing the LD array 1 can be decreased.

### THIRD EMBODIMENT

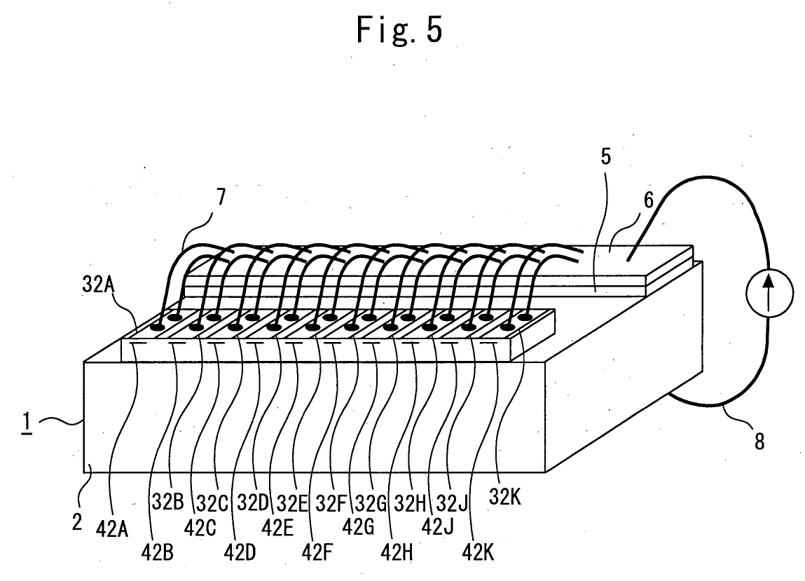

Next, a third embodiment of the invention will be described with reference to the drawings. FIG. 5 is a perspective view showing an outline construction of the third embodiment. In this figure, the same symbols as in FIG. 1 are applied to components identical with or corresponding to in FIG. 1, and descriptions thereof are omitted.

In FIG. 5, 32 is an LD bar obtained by integrally carving out a plurality of LDs from a wafer. The LD bar is mounted so that reverse sides to pn junction sides (not shown) of the respective LDs are located on the conductive sub-mount 2 side as a common electrode. As shown in the figure, electrodes 32A to 32K of the respective LDs are arranged on a top face of the LD bar 32 as independent electrodes, and the respective electrodes 32A to 32K and the metal plate 6 are connected through the bonding wire 7. 42A to 42K represent light emitting regions of the respective LDs 32A to 32K.

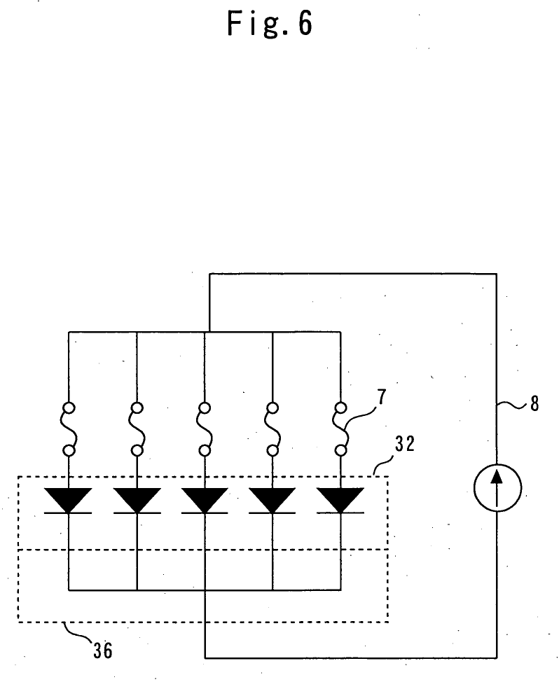

FIG. 6 shows a circuit diagram of the LD array 1 of FIG. 5. 36 is a substrate part of the LD bar 32 becoming the electrode common to the plurality of LDs.

In this case, when one LD in the LD bar 32 causes a short circuit trouble, a current concentrates on the LD in the short circuit trouble. However, only the bonding wire 7 for this one LD fuses itself, and only this LD is separated from the circuit. Therefore, the other LDs in the LD bar 32 can continue oscillation.

In this embodiment, it is advantageous that the number of the LD bar, which is required to be die-bonded is only one.

### FOURTH EMBODIMENT

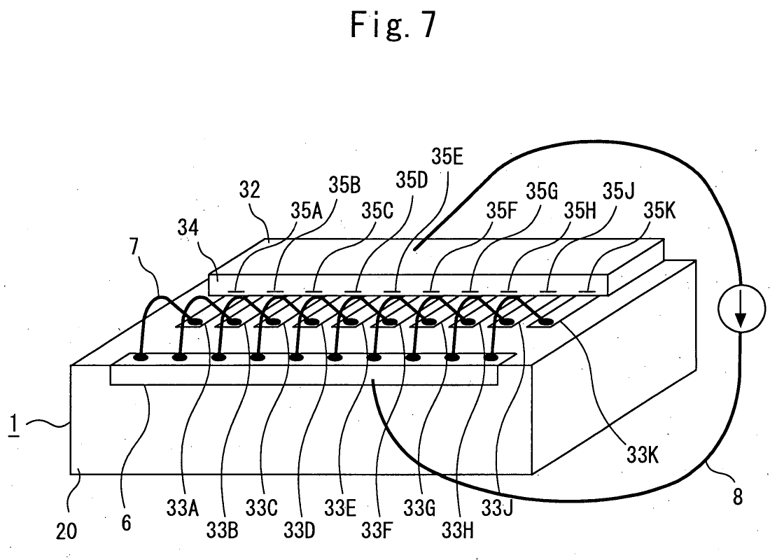

Next, a fourth embodiment of the invention will be described with reference to the drawings. FIG. 7 is a perspective view showing an outline construction of the fourth embodiment. While FIG. 5 of the third embodiment shows the LD array 1 including the LD bar 32, which is viewed from a front end face side, FIG. 7 shows the LD array 1 viewed from a rear end face side.

In FIG. 7, in the LD array 1, the foregoing LD bar 32 is mounted on a sub-mount 20 made of insulative AlN; the metal plate 6 becoming a conductive part is mounted in a position estranged from the LD bar 32; the LD bar 32 is mounted so that pn junction sides (not shown) of respective LDs contact the sub-mount 20; a plurality of metallized 33A to 33K, whose ends are respectively connected to electrodes on the pn junction sides of the respective LDs, that is electrodes on light emitting point sides, and which are provided with patterning is mounted on the sub-mount 20 to extend themselves toward the metal plate 6 side; and the respective metallized and the metal plate 6 are connected through the bonding wire 7 formed similarly to in the first embodiment.

34 represents a rear end face of the LD bar 32. 35A to 35K represent light emitting regions of the plurality of LDs in the LD bar 32. Further, 8 is a drive circuit of the LD array 1.

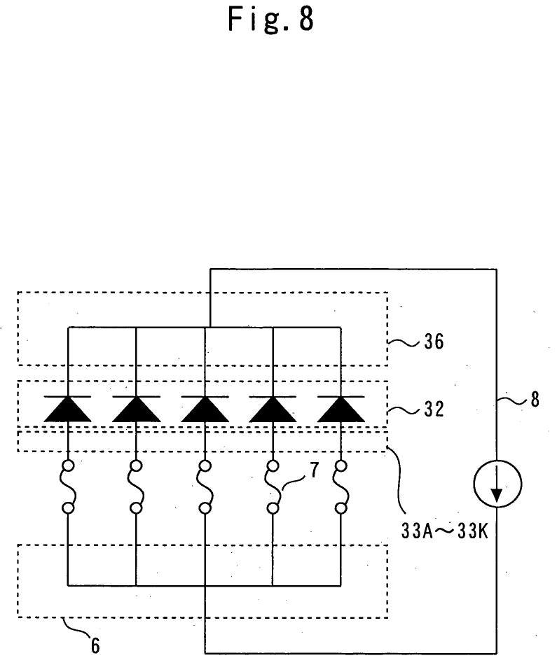

FIG. 8 shows a circuit diagram of the LD array 1 of FIG. 7. 36 is a substrate part of the LD bar 32 becoming an electrode common to the plurality of LDs.

When one LD in the LD bar 32 causes a short circuit trouble, the bonding wire 7 fuses itself, and releases the LD in trouble from the circuit. Therefore, actions and effects similar to of the foregoing respective embodiments can be obtained.

Further, in this embodiment, the LD bar 32 is mounted on the sub-mount 20 so that the pn junction sides of the respective LDs contact the sub-mount 20. Therefore, there are advantages that good heat release characteristics can be obtained, and the number of the LD bar, which is die-bonded is only one. Further, also in this embodiment, only one LD in the short circuit trouble is separated from the circuit automatically, and oscillation of the whole LD array can be continued.

In the foregoing respective embodiments, the cases using CuW or AlN as a component material for the sub-mount have been described. However, materials are not limited thereto, and similar effects can be expected by using a material such as SiC and Si.

Further, a heat sink can be used instead of the sub-mount, and LDs and the like can be die-bonded to the heat sink. Further, though the case using Au as a material for the bonding wire has been described, materials are not limited thereto. Similar effects can be expected by using other material such as a gold alloy, aluminum (Al), an aluminum alloy, copper (Cu), and a copper alloy. For example, in the case of using Al, the appropriate diameter of the wire and the appropriate number of wires of the bonding wire, which fuses itself when overcurrent of 5 A to 6 A in relation to operating current of 1 A of LD (500% to 600% in relation to the operating current) is applied, were 25 μm in diameter and 10 pcs, 20 μm in diameter and 16 pcs, or 30 μm in diameter and 7 pcs.

The major benefits of the present invention described above are summarized as follows:

It becomes very easy to design a whole system using a high power LD array not to be stopped by a short circuit trouble of one LD in the array. In addition, when an overcurrent is applied to the LD, which has caused the short circuit trouble, it is possible to avoid damage to a semiconductor chip including that LD.

Further, the present invention is not limited to these embodiments, but variations and modifications may be made without departing from the scope of the present invention.

1. An optical semiconductor module comprising:
at least one semiconductor chip, each chip including at least one laser diode;
a sub-mount or a heat sink, on which the at least one semiconductor chip is mounted; and
a bonding wire supplying an operating current to the semiconductor chip, wherein material, diameter, and shape of the bonding wire are selected so that the bonding wire fuses itself when an overcurrent exceeding operating current of the laser diode is applied.

2. The optical semiconductor module according to claim 1, wherein the semiconductor chip is mounted so that a pn junction side of the laser diode contacts the sub-mount or the heat sink.

3. The optical semiconductor module according to claim 2, wherein the sub-mount or the heat sink is electrically conductive and the bonding wire is connected to a substrate side of the semiconductor chip.

4. The optical semiconductor module according to claim 1, wherein the sub-mount or the heat sink is electrically insulating, and respective electrodes on the pn junction sides of the laser diodes are independent for each laser diode, and including a plurality of metallizations respectively connected to the electrodes and formed for each respective laser diode on the sub-mount or the heat sink, wherein the bonding wire is connected to the metallization.

5. The optical semiconductor module according to claim 1, wherein, in the semiconductor chip, electrodes on pn junction sides of the laser diodes are independent for each laser diode, the semiconductor chip is mounted so that reverse sides to the pn junction sides contact the sub-mount or the heat sink, and the bonding wire is connected to the electrode of the semiconductor chip.

6. The optical semiconductor module according to claim 1 comprising a conductive part, which is mounted to the sub-mount or the heat sink, and which is electrically separated from the semiconductor chip, wherein the bonding wire is connected to the conductive part.

7. The optical semiconductor module according to claim 1, wherein the semiconductor chip is a single laser diode.

8. The optical semiconductor module according to claim 1, wherein the semiconductor chip is a laser diode bar.
